(19) United States
(12) Patent Application Publication
(10) Pub. No.: US 2018/0103146 A1
(43) Pub. Date: Apr. 12, 2018

(54) INTELLIGENT ABSTRACTED CALL ROUTING

(71) Applicant: Microsoft Technology Licensing, LLC, Redmond, WA (US)

(72) Inventors: Calvin Choe, Redmond, WA (US); Michael Kostersitz, Snohomish, WA (US); Shai Guday, Redmond, WA (US)

(73) Assignee: Microsoft Technology Licensing, LLC

(21) Appl. No.: 15/288,964

(22) Filed: Oct. 7, 2016

(51) Int. Cl. H04M 3/42; H04M 7/00; H04M 1/2745; H04M 1/725

(52) U.S. Cl. CPC H04M 3/42263; H04M 7/0033; H04M 2203/551; H04M 1/72583; H04M 1/274508

(57) ABSTRACT

Embodiments relate to virtual call routing to enable a user (caller) to communicate with another person (callee) without specifying details of calling. A variety of independent communication channels are selected from and prioritized for calling the callee. The channels may be independent in that they might not communicate with each other, share a common backend support service, operate through a same common local application or local background communication service, use a same communication network, etc. Any real-time person-to-person communication channel (application) on a calling device can potentially be used to attempt to reach the callee. Even if the callee has multiple unrelated identities on multiple different channels, the caller can focus on specifying the person to be called and perhaps conditions for the call without regard for which channels are available, which channels and/or identities are likely to succeed, or which channels are suitable to the conditions.

### BACKGROUND

Costs have gone down for computer hardware and network communication. In addition, there has been increasing variety in the types of software and systems available for facilitating real-time person-to-person communication (“calling” for short). The proliferation of devices, networks, and applications available for calling has created a problem observed only by the instant inventors. At any given time, a person might potentially be reachable through a large number of calling options but someone intending to call that person has no way to know which calling option is most likely to succeed.

Consider a person who regularly uses multiple computing devices, each with multiple calling platforms. The person may have multiple identities and perhaps multiple identities on some of the calling platforms. Not only might there be many options for potentially calling the person, the viability of those options can change significantly over conditions such as time, location, and other conditions. One of the person's devices might be powered off. Another device, perhaps at another time, might not be able to communicate with a particular network. At other times, a privacy setting might render certain applications unavailable. Sometimes the person might be busy and unable to respond to calls to particular devices or to particular identities associated with the person. Network conditions might make one form of communication (e.g., video calling) impossible. So many variables can affect the likelihood of a particular calling option being successful that it is difficult or impossible for a person to keep track of or predict the best calling option to reach a particular person at any given time.

Although it is known that calling channels can generally be automatically monitored and avoided when offline, when multiple calling channels are apparently available for calling, it is difficult for the caller to know which of those channels are most likely to result in actual person-to-person communication with the callee. Over time, which calling channel is the best option may depend on conditions that are difficult for a user to perceive or predict.

Techniques related to intelligent call routing are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to virtual call routing to enable a user (caller) to communicate with another person (callee) without specifying details of calling. A variety of independent communication channels are selected from and prioritized for calling the callee. The channels may be independent in that they might not communicate with each other, share a common backend support service, operate through a same common local application or local background communication service, use a same communication network, etc. Any real-time person-to-person communication channel (application) on a calling device can potentially be used to attempt to reach the callee. Even if the callee has multiple unrelated identities on multiple different channels, the caller can focus on specifying the person to be called and perhaps constraints for the call without regard for which channels are available, which channels and/or identities are likely to succeed, or which channels are suitable to the constraints.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a computing device configured with a variety of calling options.

FIG. 2 shows an example of a contacts data structure.

FIG. 3 shows examples of types of channels and how they may be used.

FIG. 4 shows how a call request is routed.

FIG. 5 shows details of a virtual call router.

FIG. 6 shows an example call log.

FIG. 7 shows an example channel availability history.

FIG. 8 shows an example of routing logic.

FIG. 9 shows details of a computing device.

### DETAILED DESCRIPTION

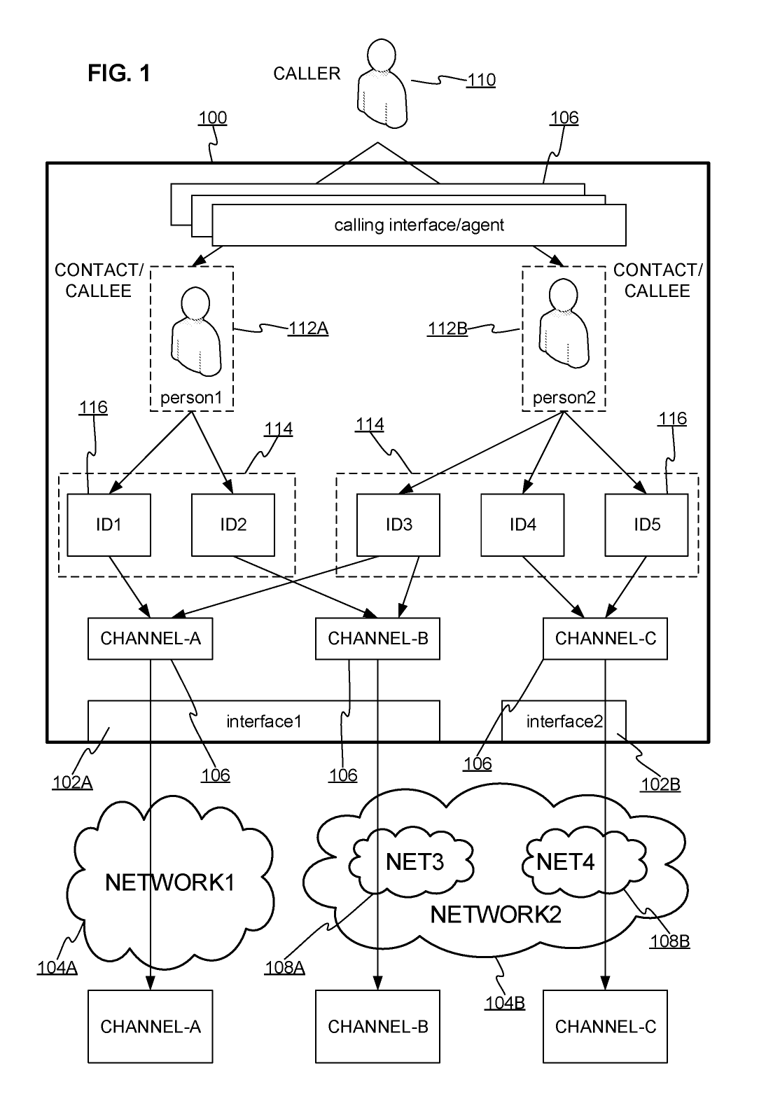

FIG. 1 shows a computing device 100 configured with a variety of calling options. The device 100 includes one or more network interfaces 102A, 102B for communicating over one or more networks 104A, 104B. Calling software, i.e., channels 106, is included to execute on processing hardware of the computing device 100. Each channel 106 generally executes at the application layer and may be a distinct application such as a video chat client, a softphone for making telephone calls, an Internet-based voice over IP (Internet Protocol) client, and so forth.

The channels 106 are configured for real-time exchange of remote and local communication data, e.g., text, voice, and/or video data, as well as call management data for establishing and managing connections with remote software. Remote communication data is inputted by a user at a remote calling application, encoded, transmitted over one or more networks 104A, 104B, received through a network interface 102A, 102B, passed up through a communication protocol stack of the computing device 100, and decoded and rendered by the corresponding local calling application. Local calling data is similarly conveyed from the local device 100 to the remote device. Calling data may be exchanged synchronously or asynchronously. In some cases, the calling application may also communicate with a communication service/network 108A, 1088, which can intermediate the exchange of communication and/or management data, aid in helping calling applications/devices locate and connect with each other on a network 104B, manage user identities and credentials, provide gateways between networks (e.g., between telephony networks and data networks), authenticate calls to user identities, and so forth. In one embodiment, the different communication services/networks are operated by different providers, have their own user identifier namespaces, etc. One communication channel/application may be configured to use a first communication service/network to make calls and another communication channel/application may be configured to use a second communication service/network to make calls. In some cases, the first communication service does not service calls placed through the second communication service/network, and the second communication service/network does not service calls placed through the first communication service/network. Servicing calls might entail helping a calling device identify an address or device endpoint for placing a call, routing call setup messages, authenticating callers and/or callees, bridging calls between data or telephone networks, and others.

The device 100 also includes a software layer that provides the caller 110 with a single point for abstracted access to the channels 106. The software layer will be referred to as a calling agent 109. The calling agent 109 can be an independent module such as a background executable process, part of one of the applications/channels 106, an element of a user shell, or any other component capable of identifying callees and possibly interacting with the channels 106 to invoke calls thereon. In one embodiment, the calling agent 109 is implemented in an intelligent agent or intelligent personal assistant (IPA). IPAs typically use machine learning and disparate information sources to make inferences about user intent for purposes such as providing information or performing actions such as making calls.

The calling agent 106 maintains or accesses a set of identities of unique users, i.e., contacts 112A, 112B. Each contact 112A, 112B represents a unique person or entity and is associated with a set 114 of user identifiers 116. Whenever a callee/contact is referenced by the calling agent 106, based on an association with a set 114 of identifiers for that contact, the calling agent 106 is able to identify all of the possible combinations of identifiers and channels that are potentially available to call the contact. As discussed below, given a contact, the calling agent 106 is able to provide a virtual call router with a corresponding list of ID-channel candidates that the virtual call router can filter and prioritize for making a call.

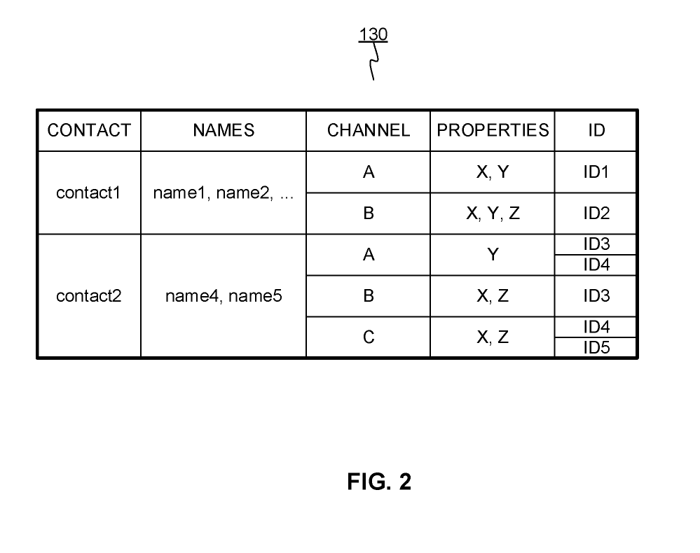

FIG. 2 shows an example of a contacts data structure 130 that can be used to track which ID-channel pairs are associated with which contacts. As noted, in one embodiment, the contacts data structure 130 is merely a table or a contacts database managed by a personal information manager (PIM) or the like and the calling agent 106 accesses contacts through a published application programming interface (API). In another embodiment, the calling agent 106 maintains its own contacts data structure 130 by collecting and collating information about persons the caller interacts with and the means of those interactions. In another embodiment, the contacts data structure 130 is a combination of contact sources, e.g., a PIM's contact database, a set of identities associated with a channel, a list of user identities from a network resource, or others. As can be seen in FIG. 2, depending on the types of channels, one ID of a contact might be associated with multiple channels (e.g., the same email address might be used by a video call service as well as a chat client). Also, a single contact might have multiple IDs for a same channel. For instance, a contact might have multiple cellular telephone numbers, or, the contact might have multiple user names on a same voice-calling platform. In short, channels and IDs can be many-to-many.

In one embodiment, the contacts data structure might include a field for each channel to store traits of the channels (X, Y, Z in FIG. 2), such as the generic type of communication (e.g., voice), the type of network used (Internet or cellular), whether a channel involves costs, etc. In addition, names such as nicknames, labels, proper nouns, or other words by which each contact has been referred to or associated with can also be stored in association with a contact record. Regardless of the form of the contacts data structure 130 or the software that manages it, of note is tracking which IDs a contact has for which communication channels. Given a name or phrase for a contact, a calling agent should be able to identify which contact/person is being referred to and hence which channel-ID combinations are potential candidates for calling the contact.

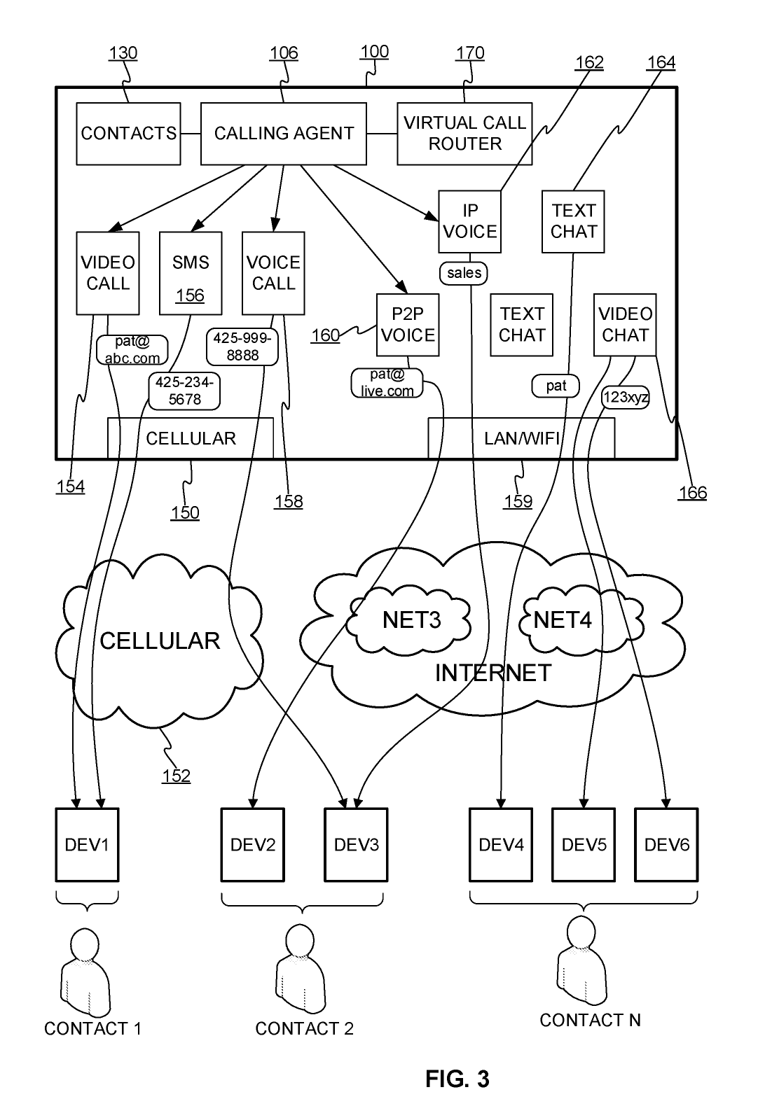

FIG. 3 shows examples of types of channels and how they may be used. The device 100 is equipped with a cellular module 150 (radio, SIM/UICC, protocols, etc.) for communicating with a cellular network 152. The device 100 also includes application software such as a video calling application 154, a Short Message Service (SMS) client 156, and a softphone or cellular voice application 158. Each of the cellular communication applications is treated as a respective channel. The device 100 may also have a suite of IP-based calling applications for making calls through an IP module 159 (interface(s) and IP protocol stack). The IP-based calling applications, or channels, might include a peer-to-peer voice application 160, a voice over IP (VoIP) application 162, a text chat client 164, a video chat application 166, or other known forms of person-to-person communication software such as a shared drawing space.

If the calling agent 106 determines that a contact named “Pat” is to be called, the calling agent 106 accesses the contacts data structure 130 and determines which contact “Pat” refers to. The calling agent 106 then identifies all of the channel-IDs for the callee contact, as shown in FIG. 3. For instance, the callee might be potentially reachable at the following channel-IDs: cellular video call at “pat@abc.com”; SMS at “425-234-5678”, cellular voice call at “425-999-8888”, peer-to-peer voice at “pat@live.com”, VoIP at “sales”, text chat at “pat”, or IP video chat at “123xyz”. The calling agent 106 passes these channel-IDs of the callee to a virtual call router 170. The virtual call router 170 prioritizes and perhaps filters the channel-IDs and either attempts to make calls through the prioritized channels or returns a prioritization of the channel-IDs to the calling agent 106, which then attempts calls accordingly. In another embodiment, the abstract identity of the callee (e.g., “Pat”) is passed to the virtual call router and the virtual call router determines which contact is being called.

Notably, the communication applications that are part of respective communication channels may be autonomous with respect to each other. The applications may be objects distinctly installed on the computing device 100. The communication applications may be represented in a user shell of the computing device 100 by distinct respective user-selectable icons or the like. The communication applications may execute as distinct processes managed by the operating system on the computing device 100. Embodiments described herein form a communication layer above heterogeneous communication applications in a way that allows a calling user to communicate with contacts at a high level of abstraction, for instance by only specifying a person to communicate with. The communication layer above the communication applications is able to intelligently decide the ideal communication applications/channels to use and initiate calls thereon without the calling user having to switch applications, input identifiers of the callee, guess at the best communication channels to attempt or which order they should be used to attempt calls to the callee, etc. Calls may be initiated with any form of inter-process communication between a communication application and a calling agent or virtual call router.

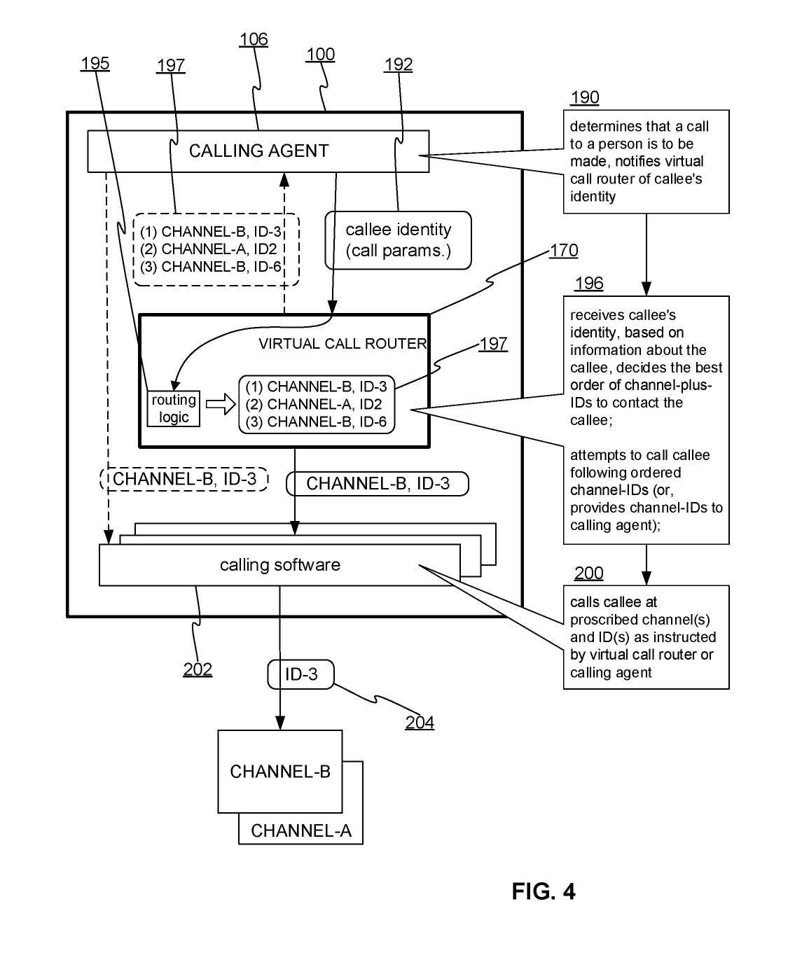

FIG. 4 shows how a call request is routed by the virtual call router 170. Initially, at step 190, the calling agent 106 determines that a call is needed for a particular person or contact. As noted above, a call to be virtually routed can be initiated automatically based on a scheduled event or meeting, a heuristic determination based on current conditions, etc. A call can also be initiated by user input specifying the contact and perhaps other conditions or constraints of the call. For example, in the case of an IPA configured for voice recognition, the user input can speak commands such as “call the plumber”, “voice call Pat”, “please make a video call to my spouse”, “please call my doctor by voice or text, but not at her office”, and so forth. A graphical interface of the calling agent 106 might include similar menu selections or means for inputting text. As noted above, the calling agent 106 functionality can also be implemented in one or more calling applications. In yet another embodiment, several calling applications can each independently function as a front-end to the virtual call router 170 and any of the calling applications might end up handling a call initiated by any of the other calling applications or routing the call to another calling application vis-a-vis the virtual call router 170. Performance of step 190 may conclude with the calling agent 106 providing the identity 192 of the callee (target contact) to the virtual call router 170. The identity 192 can be in any form that will allow the virtual call router to identify a contact in the contacts data structure 130 as the target of a call. The identity 192 may also be accompanied by call specifications, perhaps provided by the caller, such as the preferred type of channel, a preferred location or device, a number of attempts to be made, a preferred ID, etc.

At step 196 the virtual call router 170 receives the callee's identity 192 and possible call parameters. As will be described below, routing logic 195 of the virtual call router 170 identifies, from the contacts data structure 130, which channel-ID combinations are registered for the contact being called. The virtual call router 170 may filter out any channels that are determined or predicted to be unavailable, or which are precluded by call parameters. Among the remaining channel-IDs the virtual call router may draw on a wide range of current context and historical data (routing information), perhaps aided by machine learning, to rank or prioritize the channel-IDs relative to each other. In effect, as discussed below, the virtual call router 170 computes ranks, scores, or relative priorities 197 of the channel-IDs in a way that corresponds to likelihoods that calls respectively placed on the channel-IDs will result in successful communication between the caller and the callee.

Once the virtual call router 170 has prioritized the candidate channel-IDs, calls are attempted on the channel-IDs according to the order or relative priorities 197 determined by the virtual call router 170. As discussed above, either the virtual call router 170 may manage the attempts to call the channel-IDs, or the virtual call router 170 may return the priorities 197 to the calling agent 106, which in turn performs the prioritized calling (represented by dashed lines in FIG. 4).

Whether instructed by the virtual call router or the calling agent, per the priorities 197, the calling software/applications 202 (channels) for the prioritized channel-IDs are instructed to call the appropriate IDs 204. For example, a first-priority cellular voice call (CHANNEL-B) to a first phone (ID-3) number might be attempted. If the cellular voice call fails, then a second-priority IP-based voice client might be instructed to attempt to reach a particular user ID (possibly with an intermediary providing a network address of the remote device). If that fails, a third-priority cellular voice call might be attempted using a different telephone number.

In one embodiment, the virtual call router and the calling agent are modules of a same application or process and exchange data using intra-process communication. In such an embodiment, the calling agent and the virtual call router may both be logic implemented in an IPA.

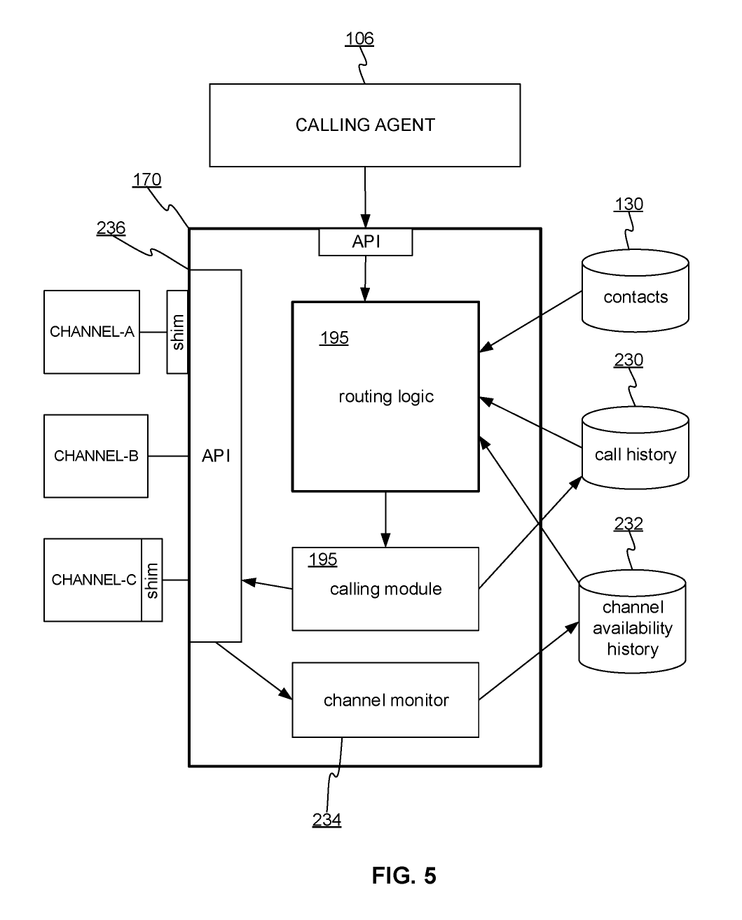

FIG. 5 shows details of the virtual call router 170. The routing logic 195 is the main decision making unit of the virtual call router. Given a target contact/callee, the routing logic 195 draws on various elements to determine how the target contact should be called. The routing logic 195 has access to the contacts data structure 130 to identify the candidate channel-IDs of the target contact. The routing logic 195 may also have access to call history data 230 and channel availability history 232. The routing logic 195 may be configured with any type of algorithms that are able to use a variety of factors associated with past outcomes to predict future outcomes. Various types of statistical models may be used to model how features related to calling can predict the likelihood of a successful call. For example, Bayesian networks, untrained learning machines, Markov networks, etc. Supervised learning algorithms may be particularly suitable, where features related to calls are the training input and are labeled with statuses of related calls.

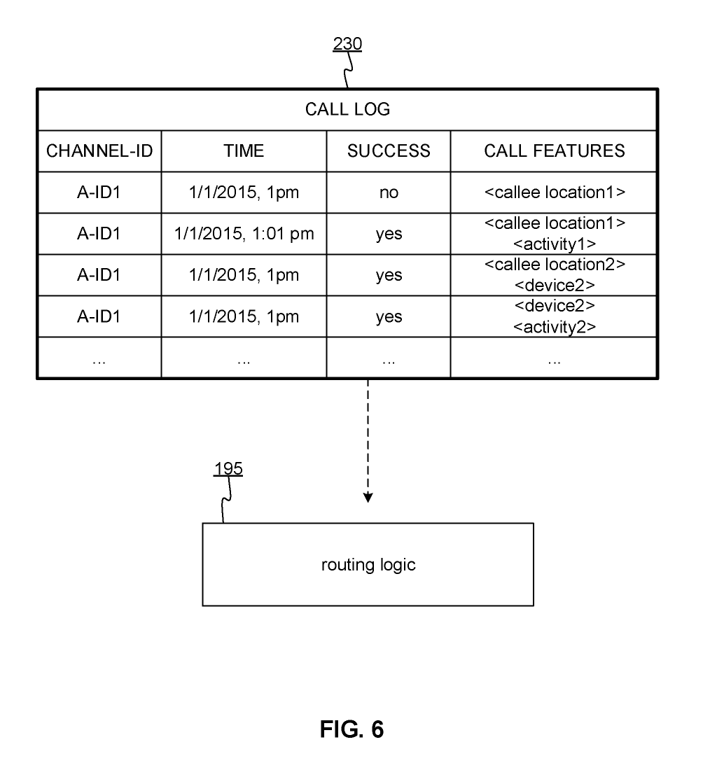

The call history data 230 is just one form of training data that can be used. The call history data 230 may be a log of past calls and any captured data (features) associated with the call. FIG. 6 shows an example call log. The outcome of each call is recorded, for example success or failure, whether a connection was established, duration, etc. In addition, features related to each call are recorded. Features can be any piece of information that can have predictive value with respect to outcomes (status) of a call attempt. Some examples include: the physical location of the callee, the time of day, the day of the week, whether the day was a holiday, an activity that the callee was engaged in, the channel, the ID used for the call, information about the channel, network conditions such as cellular reception, network bandwidth, the contact who was called, whether the call was a personal or business call, how the call was requested (e.g., automatically or explicitly), whether another contact was included in the call, a purpose associated with the call, an identity of the caller, a device that is being used by the caller (in an embodiment where call history data is shared between a user's devices), a network or network access point that was used to make the call, a location of the caller, a status of the callee on a social network, whether the callee was logged in to a network service, a type of call attempted (voice/video/text) and so forth. Other potential features would be indications of work or off-work hours from a shared calendar and traffic to and from one location to another. The IPA may have learned that a spouse drives to or from work in a specific hour, and even thought that hour may be inside or outside work hours the person will only be reachable via mobile device at that point so a call to a primary home phone or work phone will fail but a call to a secondary mobile device will succeed. Any features pertinent to a call may be captured. The availability of different channels (if known) at the time of a call can also be logged, since the chance of some channels may be functionally interrelated. The relationships between logged calls may also be captured and used as a training/prediction feature. For example, a call might be logged as having been a second-priority call made after a first-priority call failed to reach a target callee (or vice versa); links between related calls can allow a related call to also be used as a learning/prediction feature.

Returning to FIG. 5, the routing logic consumes the call log to train a statistical call model or learning machine. To conserve storage, log entries can be removed or marked as used (for log entries visible to a user) after they have been used to teach or update the predictive model of the routing logic 195.

A channel monitor 234 may also be included to monitor the availability of channels independently of placement of calls on the channels. The channel monitor 234 attempts to determine which channels are technically reachable and record the status of each channel. A channel's availability can be determined in a variety of ways. For example, the channel monitor 234 might request a calling application to report on its availability. Some calling applications are able to determine their own viability, for instance by tracking whether a necessary service or network is up or down, by determining whether the application is disabled by the user or the operating system, etc. The channel monitor 234 might also send connectivity-determining packets/information such as pings, beacons IMS presence and capability exchanges, and Session Initiation Protocol keep-alive packets for example, to determine whether remote resources needed by a channel are available. Some communication applications or services (e.g. a social network or chat service) might publish regular updates or availability status changes.

The virtual call router 170 may be configured with an API 236 to facilitate communication with the channels. The API 236 may be used by the calling applications (channels) to provide their availability status, initiate calls responsive to requests from the calling module, etc. The calling module 195 may record the results of calls in the call history data 230.

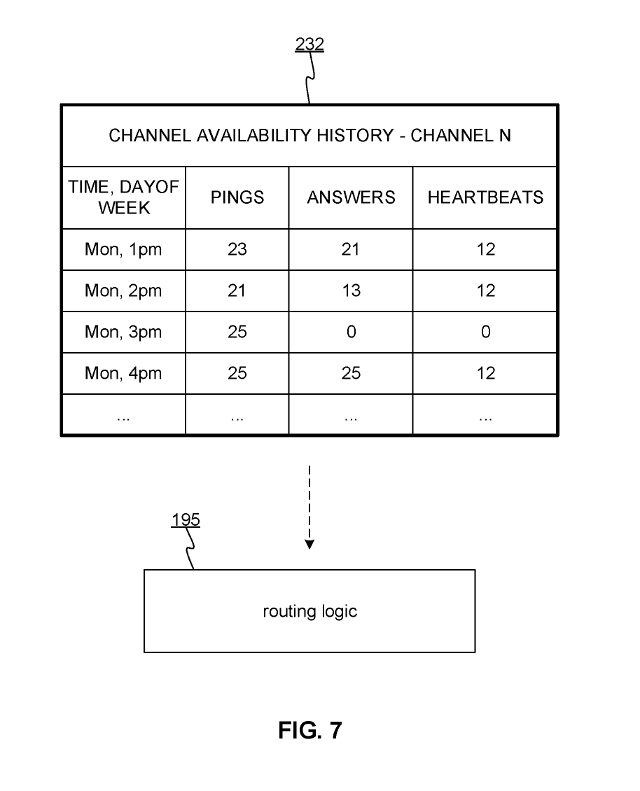

FIG. 7 shows an example channel availability history 232. Each channel may have its own availability history. Rather than tracking each piece of availability data for a channel, availability-indicating events for a channel may be consolidated into a table that stores statistics as a function of time. The number of data points for a given channel at a given time may be stored along with the number of times the channel was available or unavailable. Thus, given a time and possibly a day of the week, the table can provide a weighted probability that the channel is available based on past availability measures. The availability data may also include a current status for each channel indicating whether a channel is available or whether the availability is unknown. A channel's current status may be timestamped to evaluate its reliability and to drive re-evaluation of its availability. As noted above, the current availability statuses of one or more channels at the time of a call may be captured in to the log entry for that call. Thus, channel availability can be used both for filtering candidate channels prior to prioritization and for prioritizing channels. Conversely, attempts to make calls on channels can be used to update the current statuses of those channels.

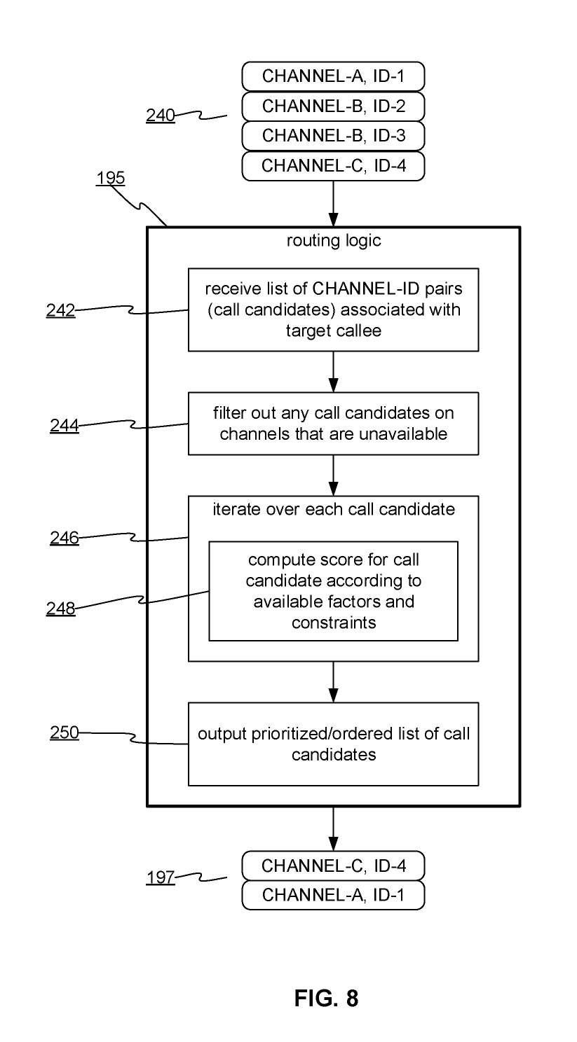

FIG. 8 shows an example of routing logic 195. The virtual call router supplies a list 240 of candidate channel-IDs that have been found to be associated with the contact being called. At step 242 the routing logic receives the list 240. At step 244 the routing logic evaluates the availability of each channel. For example, the current status of each channel (if any) is checked and if a channel is unavailable then any channel-ID pairs for that channel are filtered out. A channel is similarly filtered if the channel availability history indicates a sufficiently reliable and sufficiently high probability that the channel is unavailable.

Channel filtering need not be performed. In one embodiment, channel availability is assumed, channel-ID candidates are prioritized, and each is attempted in order. If a channel fails, then the next candidate is attempted. In another embodiment, availability is implemented in the prioritization logic and availability is accounted for as one of the modeled call features. In addition, filtering can be informed by a call parameter passed in to the virtual call router. For example, if the caller specifies that a voice call is to be made, any non-voice channels are filtered out at step 244. Current and/or past availability status may be tracked and monitored for IDs using the techniques similar to those for channels. In some cases, a channel might be available but an ID is not available. Filtering may be performed based on ID availability and historical ID availability information may be used as a feature for prioritizing channel-IDs.

At step 246, the remaining channel-ID pairs are iterated over and scored, prioritized or ranked at step 248. At step 248 a candidate channel-ID pair is evaluated. In one embodiment, a score is computed for the channel-ID being evaluated. As discussed above, a machine learning model or statistical model may be used. Current features related to the channel-ID being evaluated are used to compute a likelihood that a call on the channel-ID, given those features, would be successful. At step 250, when the candidate channel-IDs have been prioritized, the prioritized channel-IDs are outputted to whichever component will handle calling.

In another embodiment, a set of ranking rules or ranking logic is used instead of a statistical inference model. A set of prioritization rules may be in place to prioritize the channels as a function of the current call-related features (e.g., time of day, day of week, call location, callee location, contact, etc.). In another embodiment, a static scoring function may be implemented that scores each channel-ID based on fixed scoring rules that score the channel-ID pairs according to the call-related features. Feature distances may be used, where locations of a feature vector in a feature space reflect likelihoods of success or failure.

Although embodiments have been described for ordering or prioritizing combinations of channels and IDs, channels per se may be prioritized or IDs alone may be prioritized. The use of channel-ID pairs is representative of all three approaches or combinations thereof.

It will be appreciated that the virtual call router is able to take a user's intent to generically contact a person and direct that intent to a variety of communication channels even when those channels are mutually autonomous. The channels by which a person can possibly be reached are not limited to channels that locally communicate with each other, share a common backend support service, operate through a common local application or local background communication service, use a same communication network, use a same identity namespace, or share a same cloud-based resource or service. Any real-time person-to-person communication channel on the device 100 can potentially be used to satisfy a need to communicate with a particular person. Even if the person to be called has multiple unrelated identities on multiple different channels, the caller can focus on specifying the person to be called without regard for the details of which channel is available, which channels are most likely to succeed, or which channels are suitable to the nature of the call.

In addition to abstracting details of calling such as user identity, mode of communication (voice, text, etc.), etc., the virtual call router may be designed as an extensible framework that allows new communication channels to be incorporated into virtual call routing without requiring special coding for the new communication channels. Extensibility constructs such as shims, APIs, configuration settings, or the like can be used to inform the router/framework about the new calling options and details thereof.

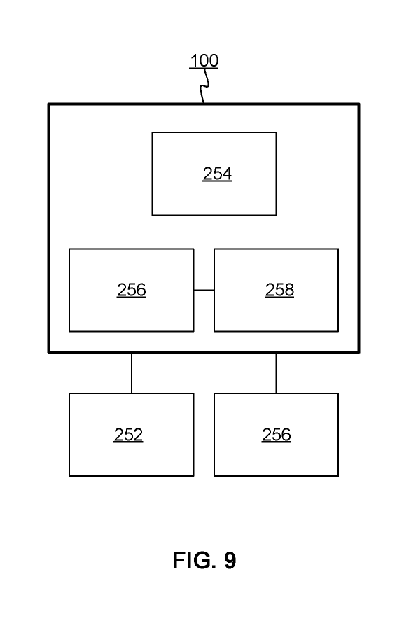

FIG. 9 shows details of the computing device 100 on which embodiments described above may be implemented. The technical disclosures herein will suffice for programmers to write software, and/or configure reconfigurable processing hardware (e.g., field-programmable gate arrays), and/or design application-specific integrated circuits (application-specific integrated circuits), etc., to run on the computing device 100 to implement any of features or embodiments described herein.

The computing device 100 may have a display 252, a network interface 254 (or several), as well as storage hardware 256 and processing hardware 258, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 256 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 100 may cooperate in ways well understood in the art of computing. In addition, input devices may be integrated with or in communication with the computing device 100. The computing device 100 may have any form-factor or may be used in any type of encompassing device. The computing device 100 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least hardware such as optical storage (e.g., compact-disk read-only memory (CD-ROM)), magnetic media, flash read-only memory (ROM), or any current or means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computing device comprising processing hardware, storage hardware, and a network interface, the storage hardware storing a plurality of communication channels, each communication channel comprising an application-level software component configured for real-time person-to-person network communication, the method comprising:
receiving a request to communicate, the request comprising an indication of a callee to be communicated with;
based on the indication of the callee, identifying communication channels and respective identifiers determined to be associated with the person;
determining current values of call conditions respectively related to the identified communication channels, and based on the current values of the call conditions, determining a priority order of the communication channels with respect to each other, wherein the priority order is determined according to information correlating prior calls with respective prior values of the call conditions, and wherein the call conditions comprise time and/or location conditions; and
establishing communication with the callee by executing instructions that will invoke one or more of the identified communication channels according to the priority order and with the respectively corresponding identifiers of the callee until one of the identified communication channels successfully establishes the communication with the callee on a remote device.

2. A method according to claim 1, wherein at least first and second identified communication channels operate autonomously with respect to each other on the computing device.

3. A method according to claim 2, wherein the first identified communication channel comprises a cellular communication application configured for real-time voice, video, or text communication over a cellular network, and wherein the second identified communication channel comprises an Internet Protocol (IP) based communication application configured for real-time voice, video, or text communication over the Internet.

4. A method according to claim 1, further comprising maintaining call history data corresponding to previous calls placed and/or received by the computing device through the communication channels and using the call history data to determine the priority.

5. A method according to claim 4, wherein the call history comprises information about whether previous calls were successful or not and times or places associated with the calls.

6. A method according to claim 1, wherein the request to communicate further comprises a parameter specified for the communication with the callee, and wherein the parameter constrains how the priority order is determined.

7. A method according to claim 1, wherein the request is provided by an intelligent personal agent (IPA) by recognizing a voice input from a caller operating the computing device, and wherein a module on the computing device that is not a communication channel determines the priority order.

8. A method according to claim 1, further comprising:
accessing a contacts data structure, either on the computing device or from a network resource, wherein the contacts data structure maps indicia of individual callees to respectively corresponding channel sets, wherein each channel set corresponds to a respective callee and comprises identifiers that represent the respective callee on respective communication channels; and
wherein the communication channels are configured to use the identifiers of a channel set to initiate calls to the corresponding callee.

9. A computing device comprising:
processing hardware;
storage hardware storing an operating system and a plurality of mutually autonomous communication channels configured to be executed by the operating system, each communication channel comprising a distinct application-layer program installed on the storage hardware;
the storage hardware further storing contacts, each contact having stored in association therewith identifiers that distinctly represent the contact, each identifier configured to be used by one or more of the communication channels to initiate a call to the contact correspondingly associated therewith;
the storage hardware further storing call routing logic configured to:
receive a set of identifiers associated with a contact, the identifiers having been selected based on a determination that a call has been requested for the contact, the call not having been requested with respect to the contact, or with respect to a particular communication channel, or with respect to a particular identifier; and
prioritize the identifiers in the received set, relative to each other, for calling the contact with the communication channels that are respectively associated with the prioritized identifiers.

10. A computing device according to claim 9, the storage further storing a calling module, the calling module configured to initiate calls to the contact by invoking the communication channels that are respectively associated with the respectively prioritized identifiers in the prioritized order.

11. A computing device according to claim 9, the call routing logic further configured to determine that communication channels are unavailable and prioritize the identifiers accordingly.

12. A computing device according to claim 9, wherein the communication channels comprise respective applications distinctly installed on the computing device and represented by respective user-selectable graphic elements of a graphic user shell.

13. A computing device according to claim 12, wherein two or more of the applications respectively correspond to two or more of the prioritized identifiers, wherein one of the two or more applications comprises an application configured to call telephone numbers, and wherein another of the two or more applications is configured to make video or text calls, and wherein a call comprises real-time exchange of call data inputted by the user and a remote user.

14. A computing device according to claim 9, wherein the routing logic comprises a statistical model or learning machine that adapts to information about past calls attempted on the communication channels to, and wherein the statistical model or learning machine prioritizes the identifiers and/or communication channels respectively configured to make calls to the prioritized identifiers.

15. A computing device according to claim 9, wherein the determination that a call has been requested for a contact is made by an intelligent personal assistant (IPA), and wherein the call routing logic is further configured to prioritize the identifiers based on a call parameter provided by the IPA, the call parameter specifying a condition to be satisfied when calling the contact.

16. A method for automated calling performed by a computing device comprising processing hardware, storage hardware, and a network interface, the storage storing a plurality of communication channels, each communication channel comprising a respective application distinctly installed to an operating system of the computing device, each application configured to execute as a respective distinct process managed by the operating system, the method comprising:
receiving an audio input inputted by a user of the computing device and responding to the audio input by analyzing the audio input, the analyzing determining that the audio input comprises an instruction to call a contact of the user;
computing a set of current calling features that a call to the contact would currently have, wherein the calling features are not specific to any of the communication channels;
based on the determining that the audio input comprises an instruction to call a contact of the user, determining scores or ranks of the applications, the scores or ranks corresponding to likelihoods of the applications, respectively, successfully calling the contact according to the current calling features; and
instructing an application with a topmost score or rank, on the basis thereof, to call the contact using an identifier associated with the contact.

17. A method according to claim 16, wherein two identifiers of the contact are associated with the application with the topmost score or rank, the computing the scores or ranks comprises computing scores or ranks for the two identifiers, and the identifier with the higher score or rank is selected for use as the identifier used to call the contact.

18. A method according to claim 16, wherein the determining the scores or ranks is based on history information corresponding to success or failure of past calls.

19. A method according to claim 18, wherein the determining the scores or ranks further comprises determining a condition associated with calling the contact and the determining the scores or ranks based on the history information is informed by the condition.

20. A method according to claim 16, wherein one of the applications is configured to use a first network-based communication service to make calls and another of the applications is configured to use a second network-based communication service to make calls, wherein the first network-based communication service does not service calls placed through the second network-based service, and wherein the second network-based service does not service calls placed through the first network-based service.
